(19) United States
(12) Patent Application Publication
(10) Pub. No.: US 2021/0188161 A1
(43) Pub. Date: Jun. 24, 2021

(54) METHOD TO INCREASE THE SAFETY FOR PEOPLE AROUND VEHICLES

(71) Applicant: Mark Obrien, Tuckahoe, NY (US)

(72) Inventor: Mark Obrien, Tuckahoe, NY (US)

(21) Appl. No.: 17/247,722

(22) Filed: Dec. 21, 2020

Related U.S. Application Data
(60) Provisional application No. 62/951,725, filed on Dec. 20, 2019.

(51) Int. Cl. B60Q 1/50

(52) U.S. Cl. CPC B60Q 1/503; B60Q 2400/50

(57) ABSTRACT

A method of increasing awareness of vehicles and pedestrians passing by a vehicle. The method embodies a vehicular signage system incorporating a signage indicia and lighting movable between a low-profile position and one or a plurality of high-profile positions as well as a downward-emitting roadway light incorporated in the vehicular signage system. The vehicular signage system is placed along an upper portion of said vehicle to increase the awareness of drivers of other vehicles through the visibility of the signage indicia and lighting as well as the downward-emitting roadway light that illuminates the workspace along the road or ground.

### CROSS-REFERENCE TO RELATED APPLICATION

This application claims the benefit of priority of U.S. provisional application No. 62/951,725 filed 20 Dec. 2019, the contents of which are herein incorporated by reference.

### BACKGROUND OF THE INVENTION

The present invention relates to vehicular signage and, more particularly, a method to increase the safety for people around vehicles through increasing the visibility of vehicular signage.

All too often there are accidents and casualties around work vehicles that are stopped on or along the roadway to perform their work. Passing vehicles who fail to recognize the potential danger posed by these stopped work vehicles, and how they impact vehicular and pedestrian traffic flows, increase the likelihood of an accident involving a pedestrian or a worker associated with the work vehicle. The lack (or lack of visibility) of the work vehicle warning signage plays a vital role in this propensity for accidents and casualties associated with work vehicles.

As can be seen, there is a need for a method to increase the safety for people around vehicles through increasing the visibility of vehicular signage. The present invention is adapted to warn all approaching vehicles to either slow down, stop or at least heed caution. The vehicular signage system embodies anywhere from a single sign unit to a multi-sign unit, all of which can be mounted on any part of the vehicle that is desired. The vehicular signage system can display any type of message and can be illuminated in such a way that they not only become highly visible, but they can also light the working area around the vehicle. This increased visibility and warning will heighten safety through awareness.

Furthermore, the present invention may give specific messages to warn approaching vehicles from any direction to be cautious, giving an added layer of protection to anyone moving and working around a vehicle that utilizes the present invention.

### SUMMARY OF THE INVENTION

In one aspect of the present invention, a method of increasing awareness of vehicles and pedestrians passing by a vehicle, the method includes the following: placing a vehicular signage system on an exterior of the vehicle, wherein the vehicular signage system includes one or more signage indicia; one or more light emitting devices; and a downward-facing roadway light, wherein the one or more light emitting devices face in an indica direction of the one or more signage indicia, wherein the downward-facing roadway light is emitting light in a downward direction orthogonal to the indicia direction, wherein the one or more signage indicia are pivotably connected to the exterior in such a way as to be movable between a low-profile position and one of a plurality of high-profile positions, wherein the one or more signage indicia are two signage indicia pivotably connected relative to each other in such a way that each occupy different high-profile positions of the plurality of high-profile positions, wherein the exterior is an upper portion of the vehicle, wherein the one or more signage indicia and a supporting substrate are made of a reflective material; and activating the one or more light emitting devices and the downward-facing roadway light.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, shown in use;

FIG. 3 is a perspective view of an exemplary embodiment of the present invention;

FIG. 4 is a perspective view of an exemplary embodiment of the present invention;

FIG. 5 is a perspective view of an exemplary embodiment of the present invention;

FIG. 6 is a top plan view of an exemplary embodiment of the present invention, illustrating the adjustability of between a low-profile position to one of a plurality of high-profile positions;

FIG. 7 is a perspective view of an exemplary embodiment of the present invention, shown in use;

FIG. 8 is a perspective view of an exemplary embodiment of the present invention, shown in use; and

FIG. 9 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of increasing awareness of vehicles and pedestrians passing by a vehicle. The method embodies a vehicular signage system incorporating a signage indicia and lighting movable between a low-profile position and one or a plurality of high-profile positions as well as a downward-emitting roadway light. The vehicular signage system is placed along an upper portion of said vehicle to increase the awareness of drivers of other vehicles through the visibility of the signage indicia and lighting as well as the downward-emitting roadway light that illuminates the workspace along the road or ground.

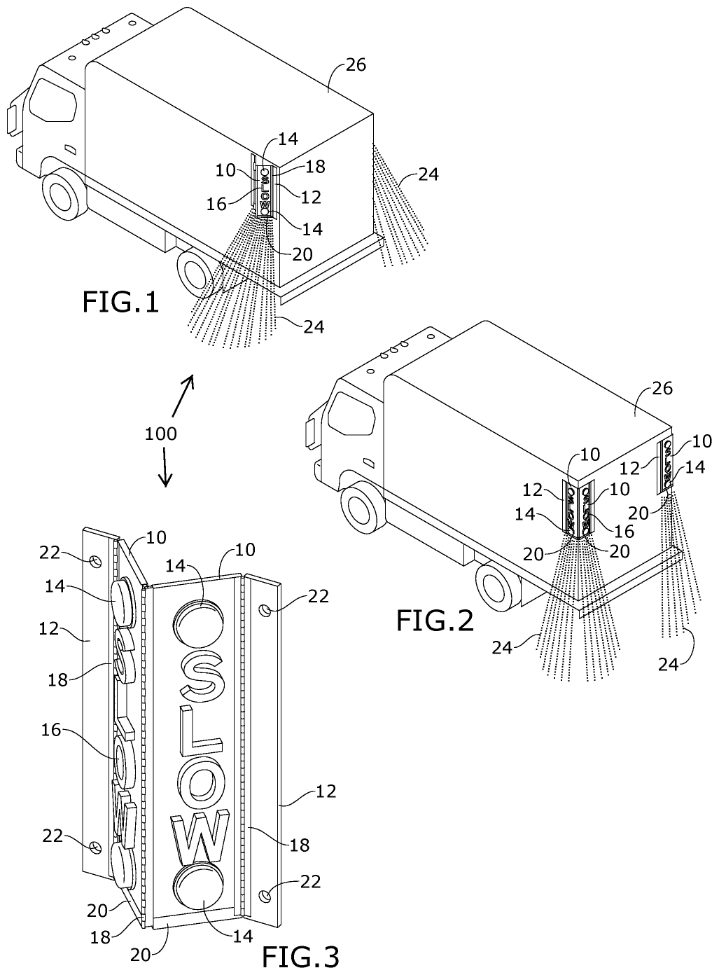

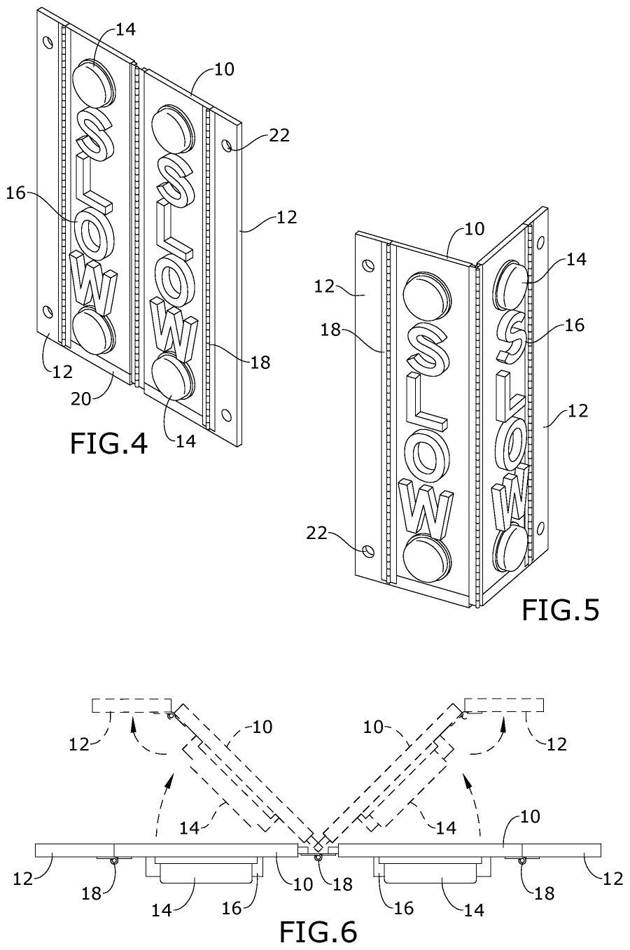

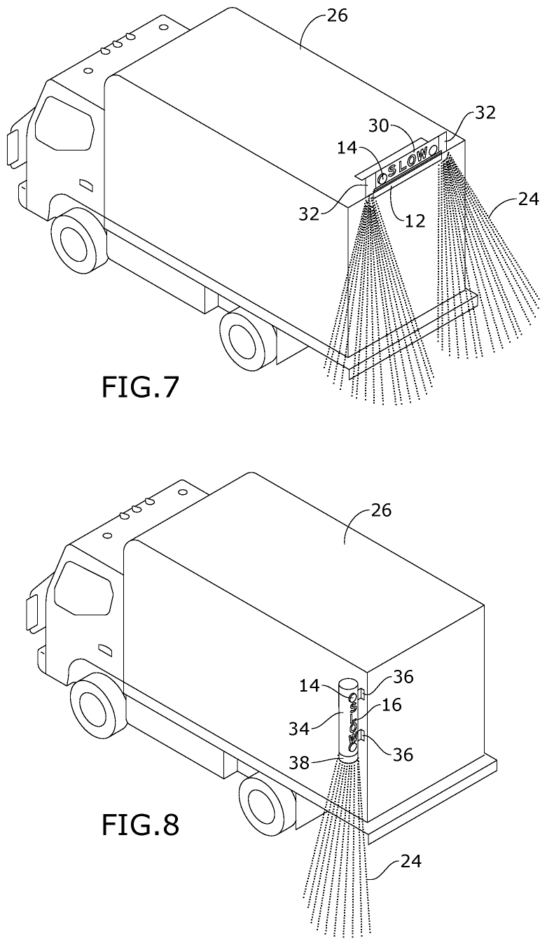

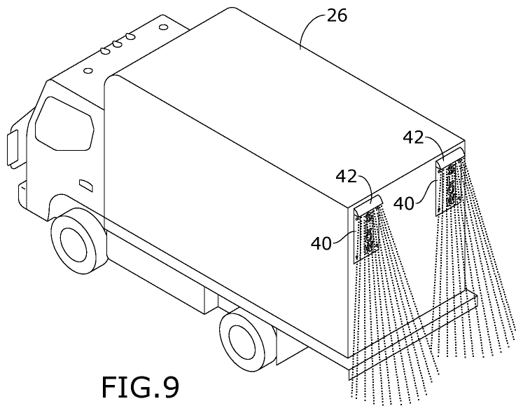

Referring now to FIGS. 1 through 9, the present invention may include a vehicular signage system 100. The vehicular signage system 100 may include one or more substrates 10, 30, 34 and/or 40. The substrate 10, 30 or 40 may be planar, the substrate 34 may be cylindrical, and/or the substrate may be any geometric shape or volume as long as it functions as contemplated herein. Each substrate 10, 30, 34 and/or 40 supports signage indicia 16 and one or more light emitting devices 14 along an exterior surface of the substrate 10, 30, 34 and/or 40. The signage indicia 16 and one or more light emitting devices 14 may face the same direction to facilitate the readability of the signage indicia 16.

Adjacent to each substrate 10, 30, 34 and/or 40 may be a mounting plate 12 or 36 attached to said associated substrate 10, 30, 34 and/or 40 along a connection point 18. The connection point may be a rigid connector in the embodiment wherein the mounting plate 36 is a bracket. In other embodiments, the connection point 18 may be a pivotable connector, such as a hinge, so that the substrate pivots about the connection point 18 independently of the associated mounting plate 12. Another portion of the mounting plate 12 or 36 may be fixed to the vehicle 26 by fasteners (via mounting holes 22) or the like. Accordingly, each substrate 10, 30, 34 and/or 40 and associated signage indicia 16 may be movable (in certain embodiments, by an actuator) between a low-profile position to one or more high-profile positions increasing the visibility of the associated signage indicia 16, as illustrated in FIG. 6. By low-profile position, it is understood that the associated signage indicia 16 is as adjacent to the outer surface of the vehicle 26 at or near where the mounting plate 12 is attached thereto. For instance, the substrates 10 may abut or be parallel with said outer surface of the vehicle 26 (as illustrated in the solid lines of FIG. 6), and as a corollary, a high-profile position embodies where the substrate 10 extends away from said outer surface of the vehicle 26 (as illustrated in the dashed lines of FIG. 6). In certain embodiments, there may be two substrates interconnected by a shared pivotable connector connection point 18, so that each substrate 10 of the two substrates 10 can effectuate their own, different high-profile position (as illustrated in the dashed lines of FIG. 6).

The vehicular signage system 100 includes one or more downward-facing roadway-lighting 32, 38, or 42. Thereby, the downward facing roadway-lighting 32, 38, or 42 projects or emits a downward light 24 directed toward the road, wherein the workers will be moving about. This downward light 24 may be orthogonal relative to the direction of the one or more light emitting devices 14. This further heightens visibility as the vehicular signage system 100 are preferably mounted along an upper portion of the vehicle 26.

The term ‘downward’ and other directional terms are to be understood in the context of the appended and incorporated by reference Figures. Specifically, the term ‘downward’ is understood to be directed toward the bottom of the perspective views, and other directional terms can be ascertained from this same frame of reference.

The vehicular signage system 100 or substrates 10, 30, 34 and/or 40 can be made of various plasticized materials or various metallic materials, preferably with a reflective face, and can be of any size or shape. The signage indicia 16 can contain any types of message, design, wording, numbers, symbols or drawings in order to convey a desired message. The signage indicia 16 can even be a LED smart sign capable of conveying multiple messages.

A method of using the present invention may include the following. The vehicular signage system 100 disclosed above may be provided. The vehicular signage system 100 may be placed in a desired space or spaces on a vehicle 26 to alert approaching vehicles of workers or pedestrians or anything else out of the ordinary on or along the roadway.

Each sign can be either rigid or movable between a low-profile position to one of a plurality of high-profile positions, thereby increasing the visibility of the signage indicia 16—the user can choose which position works best considering the factors of when and where the vehicle 26 is stopped and the type of work being engaged in.

Once activated the one or more light emitting devices 14, such as but not limited to LEDs, may emit a constant light, flashing light or the like to draw attention to the signage indicia 16. Also, the user may activate the downward-facing roadway-lighting 32, 38, or 42 to illuminate the roadway and/or ground around the workspace.

By placing the present invention in a desired place/places on a vehicle 26 the user will gain extra protection once it is switched on as the lighting and signage will heighten approaching vehicles awareness.

It should be understood, of course, that the foregoing relates to exemplary embodiments of the invention and that modifications may be made without departing from the spirit and scope of the invention as set forth in the following claims.

What is claimed is:

1. A method of increasing awareness of vehicles and pedestrians passing by a vehicle, the method comprising:
placing a vehicular signage system on an exterior of the vehicle, wherein the vehicular signage system comprises:
one or more signage indicia;
one or more light emitting devices; and
a downward-facing roadway light.

2. The method of claim 1, wherein the one or more light emitting devices face in an indica direction of the one or more signage indicia.

3. The method of claim 2, wherein the downward-facing roadway light is emitting light in a downward direction orthogonal to the indicia direction.

4. The method of claim 3, wherein the one or more signage indicia are pivotably connected to the exterior in such a way as to be movable between a low-profile position and one of a plurality of high-profile positions.

5. The method of claim 3, wherein the one or more signage indicia are two signage indicia pivotably connected relative to each other in such a way that each occupy different high-profile positions of the plurality of high-profile positions.

6. The method of claim 5, wherein the exterior is an upper portion of the vehicle.

7. The method of claim 6, wherein the one or more signage indicia and a supporting substrate are made of a reflective material.

8. The method of claim 7, further comprising activating the one or more light emitting devices and the downward-facing roadway light.
